(19) United States
(12) Patent Application Publication
(10) Pub. No.: US 2016/0057980 A1
(43) Pub. Date: Mar. 3, 2016

(54) Net Reeling Drum Apparatus

(71) Applicants: Hugo Drolet, Quebec (CA); Laury Tremblay, Quebec (CA); Jacques Morneau, Les Escoumins (CA)

(72) Inventors: Hugo Drolet, Quebec (CA); Laury Tremblay, Quebec (CA); Jacques Morneau, Les Escoumins (CA)

(21) Appl. No.: 14/472,434

(22) Filed: Aug. 29, 2014

(51) Int. Cl. A01K 73/06; A01K 75/00

(52) U.S. Cl. CPC A01K 73/06; A01K 75/00

(57) ABSTRACT

A net reeling drum apparatus has a base support frame; a rotating arm assembly rotatably connected to the base support frame defining a first axis of rotation; a rotating arm motor attached to the base support frame and mechanically connected to the rotating arm assembly for rotating the rotating arm assembly around the first axis of rotation; a drum member rotatably connected to the rotating arm assembly defining a second axis of rotation; a drum motor mechanically connected to the drum member for rotating the drum member around the axis of rotation, such that when reeling in a net line connected to a net around the drum member, the net reeling drum apparatus includes two degrees of freedom of motion that increases the ease and efficiency of reeling in the net line around the drum member.

This application claims priority based on request GB1315422.4 filed Aug. 30, 2014

### FIELD OF THE INVENTION

The present invention relates generally to commercial fishing equipment but more particularly to a net reeling drum apparatus.

### BACKGROUND OF THE INVENTION

It is a major time consuming task to untangle a fishing net as it is reeled back onto a boat. Oftentimes, the reel has to be stopped, the net untangled, and then the reeling can resume. There is no practical and efficient system to untangle fishing nets.

### SUMMARY OF THE INVENTION

In view of the foregoing disadvantages inherent in the known devices now present in the prior art, the present invention, which will be described subsequently in greater detail, is to provide objects and advantages which are:

To provide for a reeling drum apparatus that efficiently untangles fishing nets.

In order to do so, the invention is comprised of a base support frame; a rotating arm assembly rotatably connected to the base support frame defining a first axis of rotation; a rotating arm motor attached to the base support frame and mechanically connected to the rotating arm assembly for rotating the rotating arm assembly around the first axis of rotation; a drum member rotatably connected to the rotating arm assembly defining a second axis of rotation; a drum motor mechanically connected to the drum member for rotating the drum member around the axis of rotation, such that when reeling in a net line connected to a net around the drum member, the net reeling drum apparatus includes two degrees of freedom of motion that increases the ease and efficiency of reeling in the net line around the drum member.

The net reeling drum apparatus has the rotating arm motor rotatably connected to the rotating arm assembly via a first chain and sprocket assembly.

A ball bearing member facilitates the rotation of the rotating arm assembly around the first axis of rotation.

The drum motor is attached to the base support frame and mechanically connected to the drum member via a gear box located inside the rotating arm assembly and which transfers power at a right angle to a drive shaft that is also positioned inside the rotating arm assembly that extends to an end thereof and then connects with a secondary chain and sprocket assembly that is mechanically connected to the drum member to thereby rotate the drum member around the second axis of rotation.

The rotating arm motor is offset a distance upon the base support frame from the axis of rotation of the first axis of rotation passing therethrough.

The second axis of rotation is perpendicular to the first axis of rotation.

In an alternate embodiment, the rotating arm motor is controlled and operated via a hydraulic line.

The drum motor is located at a distal end of the rotating arm assembly and is controlled and operated via a hydraulic line.

The rotating arm motor and the drum motor are chosen from a group of motors that comprises electric, pneumatic, hydraulic, gas, diesel, and steam motors.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Exploded view of the invention.

FIG. 2 Front view showing the rotational range of the rotating arm.

FIG. 3 Isometric view of the invention.

FIGS. 4a-b Top and side view of the invention.

FIG. 5 Isometric view of the invention in context.

FIG. 6 Cutaway view showing an alternate embodiment using a hydraulic motor.

FIG. 7 Isometric view showing the embodiment of FIG. 6.

FIGS. 8-9 Cutaway views showing two different ways of connecting the drum rotor wherein the motor in FIG. 9 is directly connected to the shaft.

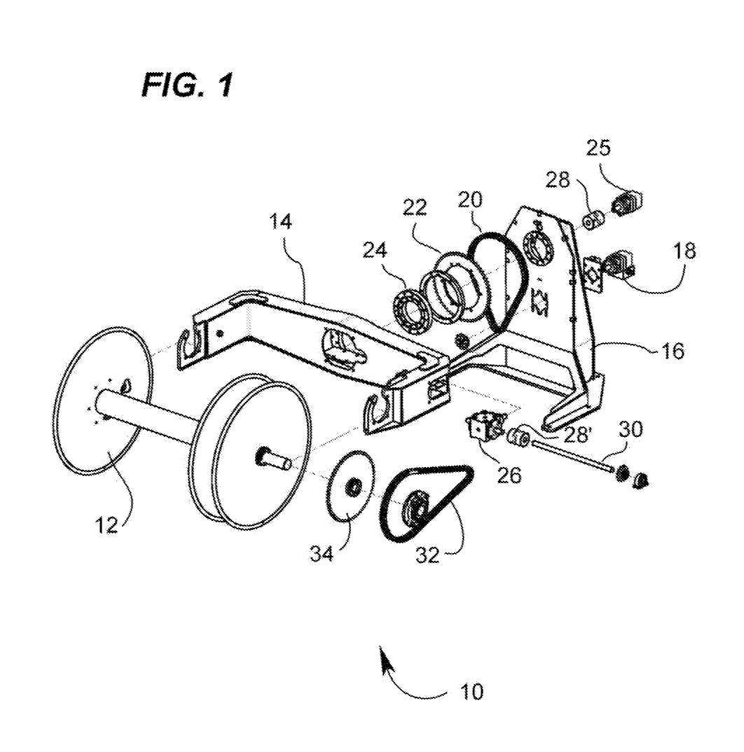

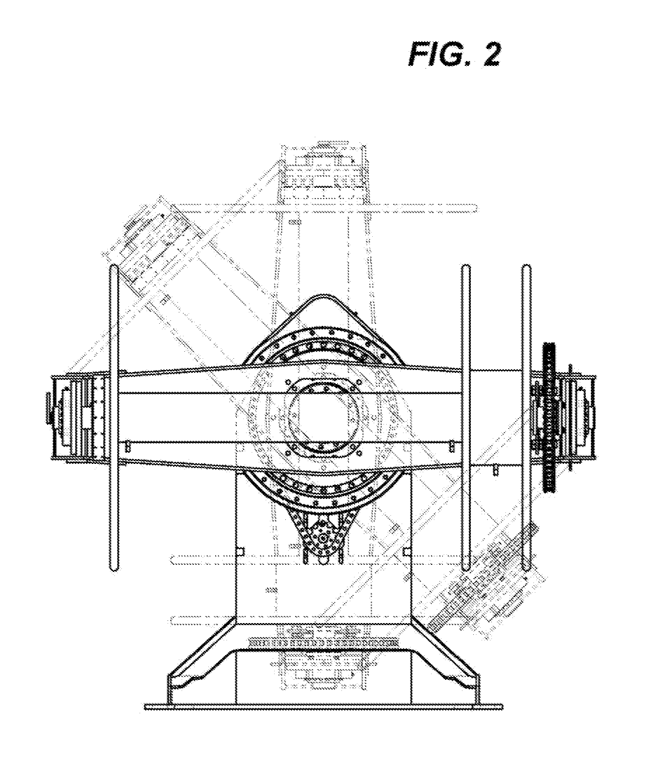

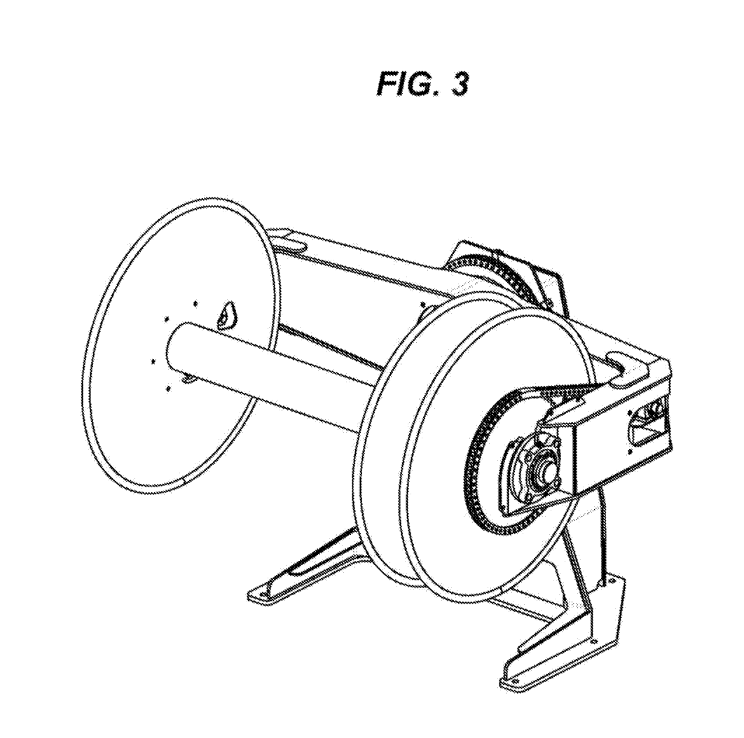

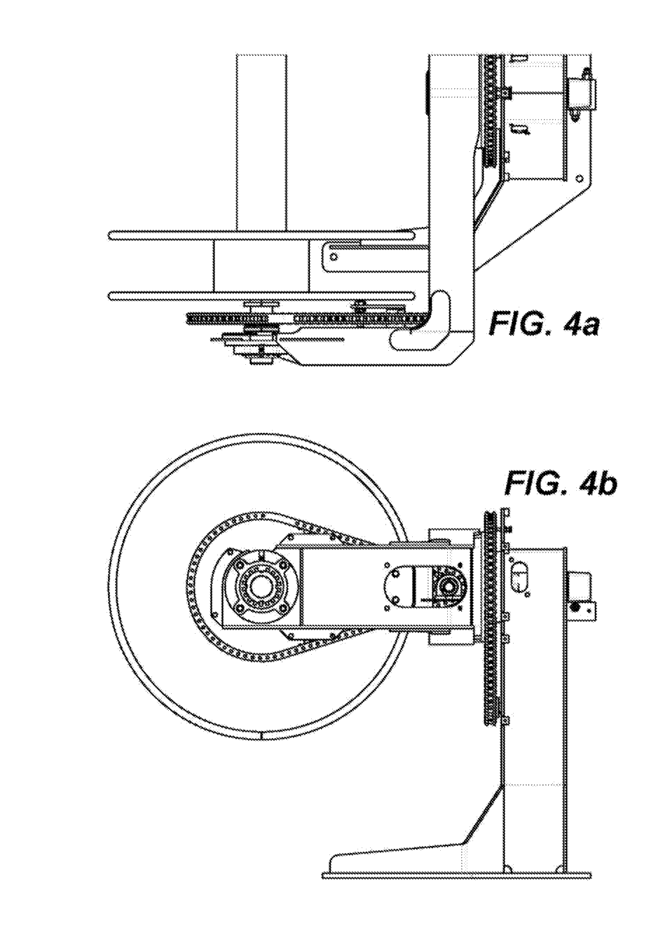

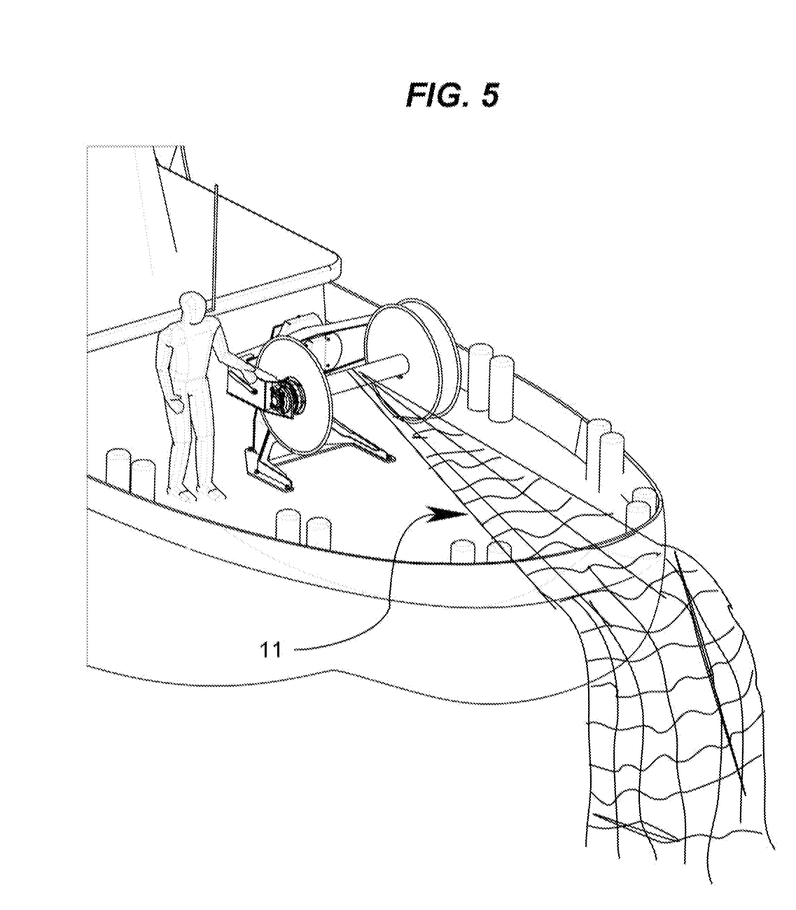

### DETAILED DESCRIPTION OF THE PREFERRED EMBODIMENT

A net reeling drum apparatus (10) for a fishing net and net line (11) has a drum member (12), a rotating arm assembly (14), and a base support frame (16).

A rotating arm motor (25) actuates the rotating arm assembly (14) by way of a first chain (20) and a first sprocket (22) assembly. A ball bearing member (24) facilitates the rotation of the rotating arm assembly (14) around its rotational axis.

A drum motor (18) connects to a gear box (26), and the gear box (26) shifts power at a right angle so as to transfer to a drive shaft (30) by way of a coupling (28′). The drive shaft (30) transfers power to a secondary chain and sprocket assembly (32, 34), which rotates the drum member (12).

The motors (18, 25) can be electric, pneumatic, hydraulic, gas, diesel, steam, or any other form of power existing or yet to be invented.

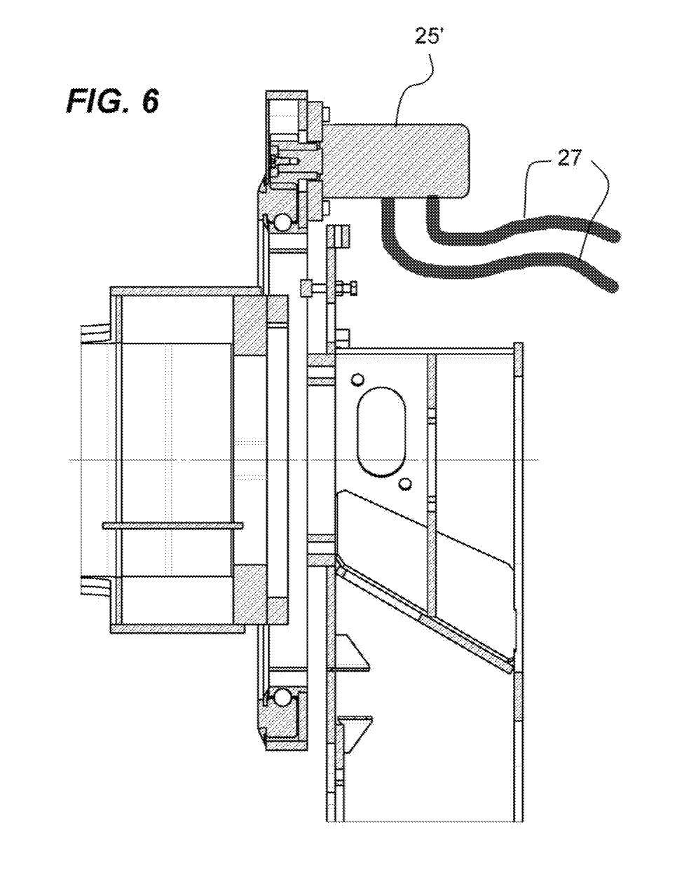

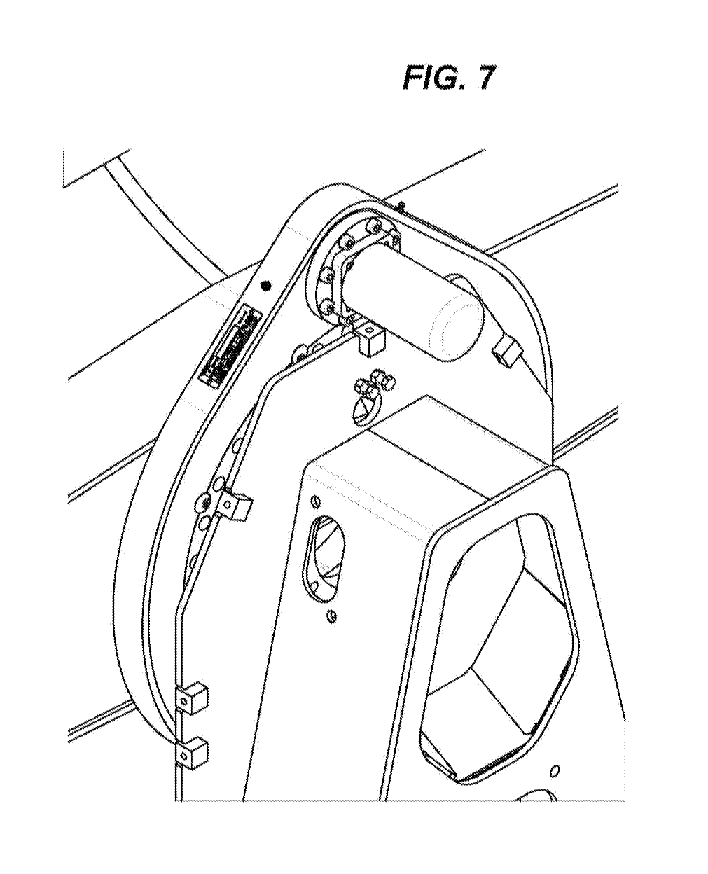

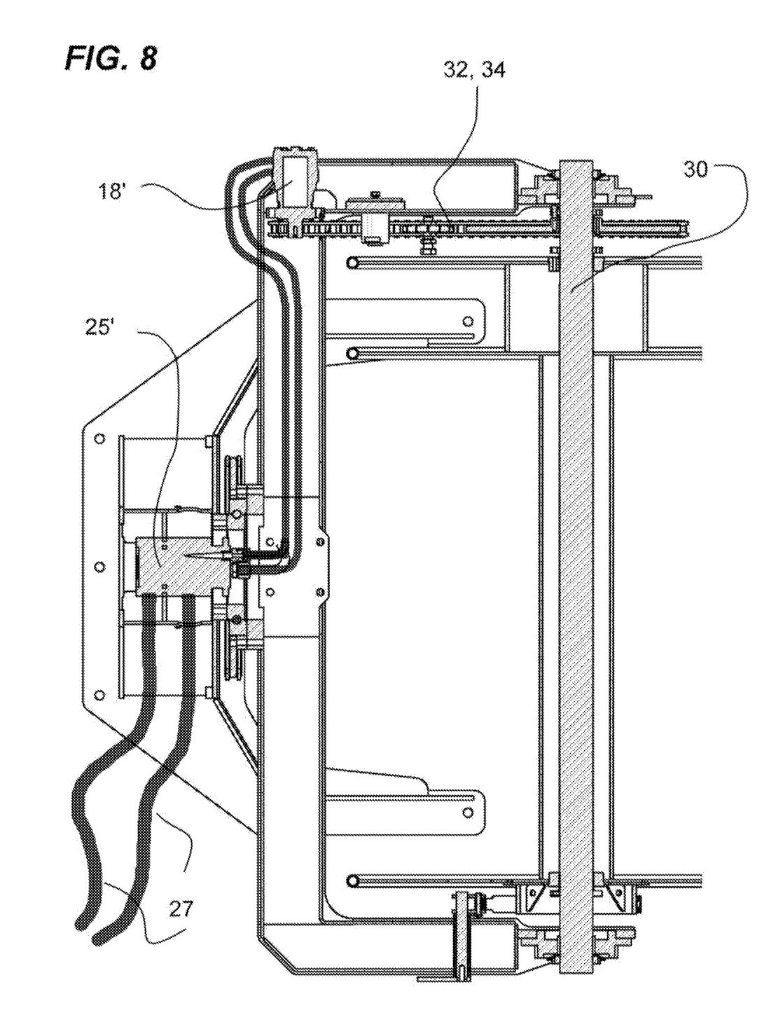

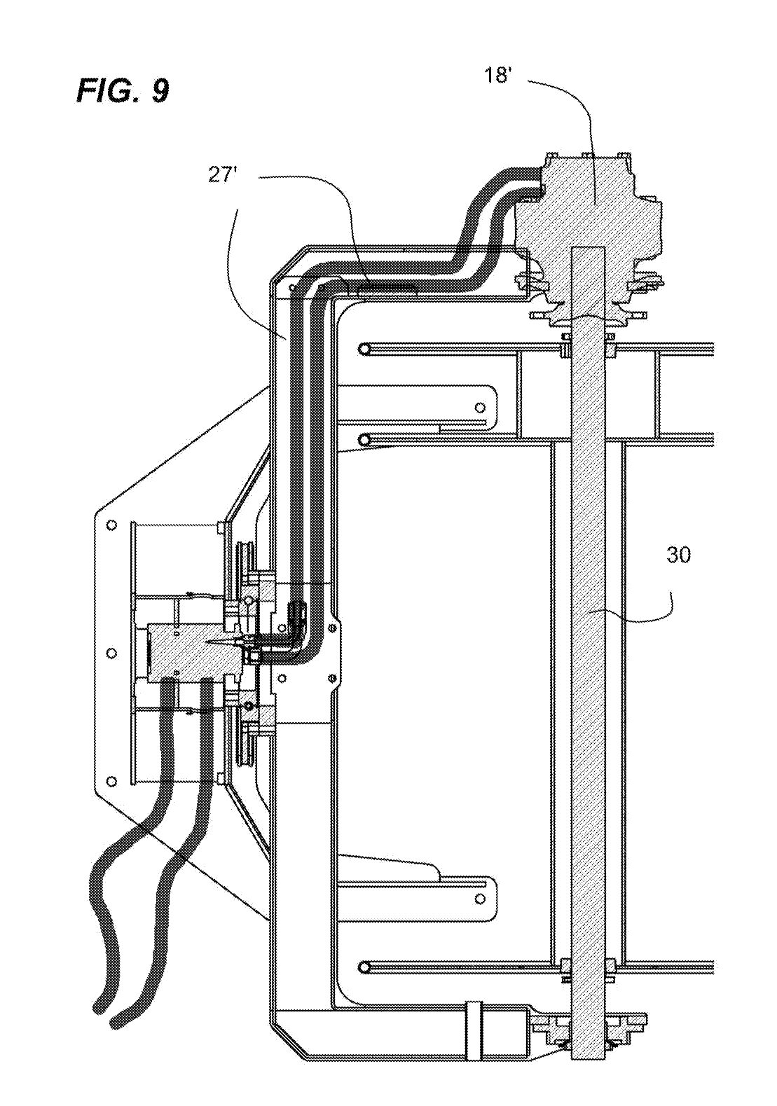

For example, FIGS. 6 through 9 show hydraulic systems variations. Hydraulic lines (27) feed hydraulic rotating arm motor (25′) and hydraulic lines (27′) feed hydraulic drum motor (18′) which turns the drum member (12) either indirectly through gears and sprockets (32, 34) as in FIG. 8, or directly through drive shaft (30) as per FIG. 9.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A net reeling drum apparatus comprising a base support frame; a rotating arm assembly rotatably connected to said base support frame defining a first axis of rotation; a rotating arm motor attached to said base support frame and mechanically connected to said rotating arm assembly for rotating said rotating arm assembly around said first axis of rotation; a drum member rotatably connected to said rotating arm assembly defining a second axis of rotation; a drum motor mechanically connected to said drum member for rotating said drum member around said axis of rotation, such that when reeling in a net line connected to a net around said drum member, said net reeling drum apparatus includes two degrees of freedom of motion that increases the ease and efficiency of reeling in said net line around said drum member.

2. The net reeling drum apparatus of claim 1, wherein said rotating arm motor is rotatably connected to said rotating arm assembly via a first chain and sprocket assembly.

3. The net reeling drum apparatus of claim 2, wherein a ball bearing member facilitates the rotation of said rotating arm assembly around said first axis of rotation.

4. The net reeling drum apparatus of claim 1, wherein said drum motor is attached to said base support frame and mechanically connected to said drum member via a gear box located inside said rotating arm assembly and which transfers power at a right angle to a drive shaft that is also positioned inside said rotating arm assembly that extends to an end thereof and then connects with a secondary chain and sprocket assembly that is mechanically connected to said drum member to thereby rotate said drum member around said second axis of rotation.

5. The net reeling drum apparatus of claim 2, wherein said rotating arm motor is offset a distance upon said base support frame from said axis of rotation of said first axis of rotation passing therethrough.

6. The net reeling drum apparatus of claim 1, wherein said second axis of rotation that is perpendicular to said first axis of rotation.

7. The net reeling drum apparatus of claim 1, wherein said rotating arm motor is controlled and operated via a hydraulic line.

8. The net reeling drum apparatus of claim 1, wherein said drum motor is located at a distal end of said rotating arm assembly and is controlled and operated via a hydraulic line.

9. The net reeling drum apparatus of claim 1, wherein said rotating arm motor and said drum motor are chosen from a group of motors that comprises electric, pneumatic, hydraulic, gas, diesel, and steam motors.

10. A combination of a fishing net, a fishing net line, and a fishing net reeling drum apparatus; said combination comprising a fishing net; a fishing net line connected to said fishing net; and a net reeling drum apparatus connected to said fishing net line for reeling in said fishing net line and said fishing net, said reeling drum apparatus comprising a base support frame; a rotating arm assembly rotatably connected to said base support frame defining a first axis of rotation; a rotating arm motor attached to said base support frame and mechanically connected to said rotating arm assembly for rotating said rotating arm assembly around said first axis of rotation; a drum member for reeling in said net line there around and pull said net thereto, said drum member rotatably connected to said rotating arm assembly defining a second axis of rotation; a drum motor mechanically connected to said drum member for rotating said drum member around said axis of rotation, such that when reeling in a net line connected to a net around said drum member, said net reeling drum apparatus includes two degrees of freedom of motion that increases the ease and efficiency of reeling in said net line around said drum member.

11. The combination of claim 10, wherein said rotating arm motor is rotatably connected to said rotating arm assembly via a first chain and sprocket assembly.

12. The combination of claim 11, wherein a ball bearing member facilitates the rotation of said rotating arm assembly around said first axis of rotation.

13. The combination of claim 10, wherein said drum motor is attached to said base support frame and mechanically connected to said drum member via a gear box located inside said rotating arm assembly and which transfers power at a right angle to a drive shaft that is also positioned inside said rotating arm assembly that extends to an end thereof and then connects with a secondary chain and sprocket assembly that is mechanically connected to said drum member to thereby rotate said drum member around said second axis of rotation.

14. The combination of claim 11, wherein said rotating arm motor is offset a distance upon said base support frame from said axis of rotation of said first axis of rotation passing therethrough.

15. The combination of claim 10, wherein said second axis of rotation that is perpendicular to said first axis of rotation.

16. The combination of claim 10, wherein said rotating arm motor is controlled and operated via a hydraulic line.

17. The combination of claim 10, wherein said drum motor is located at a distal end of said rotating arm assembly and is controlled and operated via a hydraulic line.

18. The combination of claim 10, wherein said rotating arm motor and said drum motor are chosen from a group of motors that comprises electric, pneumatic, hydraulic, gas, diesel, and steam motors.
